(19) United States
(12) Patent Application Publication
(10) Pub. No.: US 2021/0331444 A1
(43) Pub. Date: Oct. 28, 2021

(54) FLAME-RESISTANT NONWOVEN FIBER ASSEMBLY

(71) Applicant: 3M INNOVATIVE PROPERTIES COMPANY, St. Paul, MN (US)

(72) Inventors: Pingfan Wu, Woodbury, MN (US); Tien T. Wu, Woodbury, MN (US)

(21) Appl. No.: 17/309,065

(22) PCT Filed: Nov. 13, 2019
(86) PCT No.: PCT/IB2019/059757

§ 371 Date: Apr. 20, 2021

Related U.S. Application Data
(60) Provisional application No. 62/767,359, filed on Nov. 14, 2018.

(51) Int. Cl. B32B 5/26; D04H 1/43; D04H 1/4374; D04H 1/4291; D04H 1/64; B32B 5/02; B32B 5/08; B32B 5/10

(52) U.S. Cl. CPC B32B 5/266; B32B 2605/00; D04H 1/4374; D04H 1/4291; D04H 1/64; B32B 5/022; B32B 5/08; B32B 5/10; B32B 2262/0246; B32B 2260/023; B32B 2260/046; B32B 2262/0253; B32B 2262/0276; B32B 2262/12; B32B 2262/144; B32B 2307/3065; B32B 2307/54; B32B 2307/718; D10B 2505/12; B32B 2457/10; D04H 1/43

(57) ABSTRACT

A nonwoven fiber assembly. The nonwoven fiber assembly includes a nonwoven fibrous web including a plurality of discontinuous fibers; and a nonwoven fabric at least partially surrounding the nonwoven fibrous web; the nonwoven fabric including a plurality of randomly-oriented fibers, the plurality of randomly-oriented fibers comprising: at least 60 wt % of oxidized polyacrylonitrile fibers; and from 0 to less than 40 wt % of reinforcing fibers having an outer surface comprised of a (co)polymer with a melting temperature of from 100° C. to 450° C.; and a fluoropolymer binder on the plurality of randomly-oriented fibers.

### FIELD OF THE INVENTION

Provided are nonwoven fabrics and fabrics-nonwoven sandwich structure for the fabric to protect the nonwoven for flame resistant and no-fiber-shedding. The provided nonwoven fabrics may be used in thermal and acoustic insulators in automotive and aerospace applications such as battery compartments for electric vehicles. The provided nonwoven fabrics can be particularly suitable for reducing noise in automotive and aerospace applications.

### BACKGROUND

Thermal insulators reduce heat transfer between structures either in thermal contact with each other or within range of thermal convection or radiation. These materials mitigate the effects of conduction, convection, and/or radiation, and can thus help in stabilizing the temperature of a structure in proximity to another structure at significantly higher or lower temperatures. By preventing overheating of a component or avoiding heat loss where high temperatures are desired, thermal management can be critical in achieving the function and performance demanded in widespread commercial and industrial applications.

Thermal insulators can be particularly useful in the automotive and aerospace technologies. For example, internal combustion engines of automobiles produce a tremendous amount of heat during their combustion cycle. In other areas of the vehicle, thermal insulation is used to protect electronic components sensitive to heat. Such components can include, for example, sensors, batteries, and electrical motors. To maximize fuel economy, it is desirable for thermal insulation solutions to be as thin and lightweight as possible while adequately protecting these components. Ideally, these materials are durable enough to last the lifetime of the vehicle.

Historically, developments in automotive and aerospace technology have been driven by consumer demands for faster, safer, quieter, and more spacious vehicles. These attributes must be counterbalanced against the desire for fuel economy, since enhancements to these consumer-driven attributes generally also increase the weight of the vehicle.

With a 10% weight reduction in the vehicle capable of providing about an 8% increase in fuel efficiency, automotive and aerospace manufacturers have a great incentive to decrease vehicle weight while meeting existing performance targets. Yet, as vehicular structures become lighter, noise can become increasingly problematic. Some noise is borne from structural vibrations, which generate sound energy that propagates and transmits to the air, generating airborne noise. Structural vibration is conventionally controlled using damping materials made with heavy, viscous materials. Airborne noise is conventionally controlled using a soft, pliable material, such as a fiber or foam, capable of absorbing sound energy.

The demand for suitable insulating materials has intensified with the advent of electric vehicles (“EVs”). EVs employ lithium ion batteries that perform optimally within a defined temperature range, more particularly around ambient temperatures. EVs generally have a battery management system that activates an electrical heater if the battery temperature drops significantly below optimal temperatures and activates a cooling system when the battery temperature creeps significantly higher than optimal temperatures.

### SUMMARY

Operations used for heating and cooling EV batteries can substantially deplete battery power that would otherwise have been directed to the vehicle drivetrain. Just as a blanket provides comfort by conserving a person's body heat in cold weather, thermal insulation passively minimizes the power required to protect the EV batteries in extreme temperatures.

Developers of insulation materials for EV battery applications face formidable technical challenges. For instance, EV battery insulation materials should display low thermal conductivity while satisfying strict flame retardant requirements to extinguish or slow the spread of a battery fire. A common test for flame retardancy is the UL-94V0 flame test. It is also desirable for a suitable thermal insulator to resiliently flex and compress such that it can be easily inserted into irregularly shaped enclosures and expand to occupy fully the space around it. Finally, these materials should display sufficient mechanical strength and tear resistance to facilitate handling and installation in a manufacturing process such that there are no loose fibers or fiber shedding.

The provided articles and methods address these problems by using a nonwoven fabric assembly. The nonwoven fabric assembly is flame resistant and minimizes fiber shedding. The reinforcing fibers can at least partially melt when heated to form a bonded web with enhanced strength. The edges of the nonwoven fabric assembly of the current application does not need to be sealed by heat and pressure or other means. The provided nonwoven fabric assembly can also have a low flow resistance rendering the nonwoven fabric better acoustic insulators

In a first aspect, a nonwoven fiber assembly is provided. The nonwoven fiber assembly includes a nonwoven fibrous web comprising a plurality of discontinuous fibers; and a nonwoven fabric at least partially surrounding the nonwoven fibrous web; the nonwoven fabric comprising a plurality of randomly-oriented fibers, the plurality of randomly-oriented fibers comprising: at least 60 wt % of oxidized polyacrylonitrile fibers; and from 0 to less than 40 wt % of reinforcing fibers having an outer surface comprised of a (co)polymer with a melting temperature of from 100° C. to 450° C.; and a fluoropolymer binder on the plurality of randomly-oriented fibers; wherein the plurality of randomly-oriented fibers is bonded together to form the nonwoven fabric, optionally wherein the non-woven fabric has a thickness less than one millimeter.

In a second aspect, a nonwoven fabric assembly is provided. The nonwoven fiber assembly includes a non-woven fibrous web comprising a plurality of discontinuous fibers, the nonwoven fibrous web having a first major surface and an opposed second major surface; a first nonwoven fabric covering at least a portion of the first major surface; and a second nonwoven fabric covering at least a portion of the second major surface; wherein the first and second non-woven fabrics each comprises a plurality of randomly-oriented fibers, the plurality of randomly-oriented fibers comprising: at least 60 wt % of oxidized polyacrylonitrile fibers; and less than 40 wt % of reinforcing fibers having an outer surface comprised of a (co)polymer with a melting temperature of from 100° C. to 450° C.; and a fluoropolymer binder on the plurality of randomly-oriented fibers; wherein the plurality of randomly-oriented fibers is bonded together to form the first or second nonwoven fabrics, optionally wherein the first and second nonwoven fabrics each has a thickness of one millimeter or less.

### BRIEF DESCRIPTION OF THE DRAWINGS

As provided herein:

FIGS. 1-2 are side cross-sectional views of nonwoven fabric according to various exemplary embodiments.

FIGS. 3-4 are side cross-sectional view of a nonwoven fabric assembly.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. Drawings may not be to scale.

### Definitions

As used herein:

“Ambient conditions” means at 25° C. and 101.3 kPa pressure.

“Average” means number average, unless otherwise specified.

“Copolymer” refers to polymers made from repeat units of two or more different polymers and includes random, block and star (e.g. dendritic) copolymers.

“Median fiber diameter” of fibers in a nonwoven fabric is determined by producing one or more images of the fiber structure, such as by using a scanning electron microscope; measuring the transverse dimension of clearly visible fibers in the one or more images resulting in a total number of fiber diameters; and calculating the median fiber diameter based on that total number of fiber diameters.

“Calendering” means a process of passing a product, such as a polymeric absorbent loaded web through rollers to obtain a compressed material. The rollers may optionally be heated.

“Effective Fiber Diameter” or “EFD” means the apparent diameter of the fibers in a nonwoven fibrous web based on an air permeation test in which air at 1 atmosphere and room temperature is passed at a face velocity of 5.3 cm/sec through a web sample of known thickness, and the corresponding pressure drop is measured. Based on the measured pressure drop, the Effective Fiber Diameter is calculated as set forth in Davies, C. N., The Separation of Airborne Dust and Particles, Institution of Mechanical Engineers, London Proceedings, 1B (1952).

“Polymer” means a relatively high molecular weight material having a molecular weight of at least 10,000 g/mol.

“Size” refers to the longest dimension of a given object or surface.

“Substantially” means to a significant degree, as in an amount of at least 30%, 40, 50, 60, 70, 80, 90, 95, 96, 97, 98, 99, 99.5, 99.9, 99.99, or 99.999%, or 100%.

“Thickness” means the distance between opposing sides of a layer or multilayered article.

### DETAILED DESCRIPTION

As used herein, the terms “preferred” and “preferably” refer to embodiments described herein that can afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises” and variations thereof do not have a limiting meaning where these terms appear in the accompanying description. Moreover, “a,” “an,” “the,” “at least one,” and “one or more” are used interchangeably herein. Relative terms such as left, right, forward, rearward, top, bottom, side, upper, lower, horizontal, vertical, and the like may be used herein and, if so, are from the perspective observed in the particular drawing. These terms are used only to simplify the description, however, and not to limit the scope of the invention in any way.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Where applicable, trade designations are set out in all uppercase letters.

A nonwoven fiber assembly is provided. The fiber assembly include a nonwoven fibrous web comprising a plurality of discontinuous fibers and a nonwoven fabric at least partially surrounding the nonwoven fibrous web.

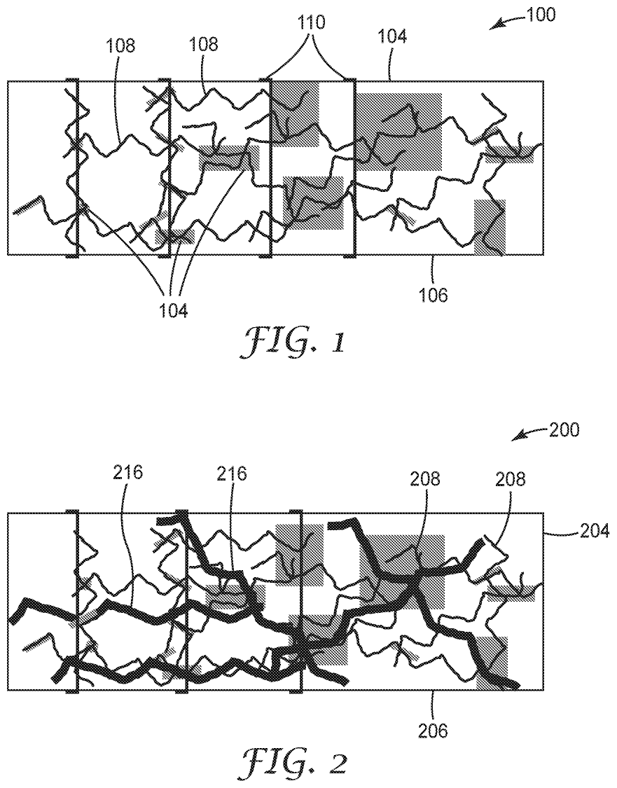

A nonwoven fabric according to one embodiment of the invention is illustrated in FIG. 1 and hereinafter referred to by the numeral 100. The nonwoven fabric 100 includes having opposed first and second major surfaces 104, 106.

The nonwoven fabric 100 is comprised of a plurality of randomly-oriented fiber, including oxidized polyacrylonitrile fibers 108. Oxidized polyacrylonitrile fibers 108 include those available under the trade designations PYRON (Zoltek Corporation, Bridgeton, Mo.) and PANOX (SGL Group, Meitingen, GERMANY).

The oxidized polyacrylonitrile fibers 108 preferably have a fiber diameter and length that enables fiber entanglements within the nonwoven fabric. The fibers, however, are preferably not so thin that web strength is unduly compromised. The fibers 108 can have a median fiber diameter of from 2 micrometers to 150 micrometers, from 5 micrometers to 100 micrometers, from 5 micrometers to 25 micrometers, or in some embodiments, less than, equal to, or greater than 1 micrometer, 2, 3, 5, 7, 10, 15, 20, 25, 30, 40, 50 micrometers.

Inclusion of long fibers can reduce fiber shedding and further enhance strength of the nonwoven fabric along transverse directions. The oxidized polyacrylonitrile fibers 108 can have a median fiber length of from 10 millimeters to 100 millimeters, from 15 millimeters to 100 millimeters, from 25 millimeters to 75 millimeters, or in some embodiments, less than, equal to, or greater than 10 millimeters, 12, 15, 17, 20, 25, 30, 35, 40, 45, 50, 55, 60, 65, 70, or 75 millimeters.

The oxidized polyacrylonitrile fibers 108 used to form the nonwoven fabric 100 can be prepared from bulk fibers. The bulk fibers can be placed on the inlet conveyor belt of an opening/mixing machine in which they can be teased apart and mixed by rotating combs. The fibers are then blown into web-forming equipment where they are formed into a dry-laid nonwoven fabric.

As an alternative, a SPIKE air-laying forming apparatus (commercially available from FormFiber NV, Denmark) can be used to prepare nonwoven fabric containing these bulk fibers. Details of the SPIKE apparatus and methods of using the SPIKE apparatus in forming air-laid webs is described in U.S. Pat. No. 7,491,354 (Andersen) and U.S. Pat. No. 6,808,664 (Falk et al.).

Bulk fibers can be fed into a split pre-opening and blending chamber with two rotating spike rollers with a conveyor belt. Thereafter, the bulk fibers are fed into the top of the forming chamber with a blower. The fibrous materials can be opened and fluffed in the top of the chamber and then fell through the upper rows of spikes rollers to the bottom of the forming chamber passing thereby the lower rows of spike rollers. The materials can then be pulled down on a porous endless belt/wire by a combination of gravity and vacuum applied to the forming chamber from the lower end of the porous forming belt/wire.

Alternatively, the nonwoven fabric 100 can be formed in an air-laid machine. The web-forming equipment may, for example, be a RANDO-WEBBER device commercially-available from Rando Machine Co., Macedon, N.Y. Alternatively, the web-forming equipment could be one that produces a dry-laid web by carding and cross-lapping, rather than by air-laying. The cross-lapping can be horizontal (for example, using a PROFILE SERIES cross-lapper commercially-available from ASSELIN-THIBEAU of Elbeuf sur Seine, 76504 France) or vertical (for example, using the STRUTO system from the University of Liberec, Czech Republic or the WAVE-MAKER system from Santex AG of Switzerland).

As indicated by the color contrast in FIG. 1, the nonwoven fabric includes a fluoropolymer binder on the plurality of randomly-oriented fibers, for example, on the oxidized polyacrylonitrile fibers 108. The fluoropolymers on the plurality of randomly-oriented fibers can self-bond so that fluoropolymers can confine the fibers and substantially reduce fiber shedding. In addition, the fluoropolymers enable the nonwoven fabric to have an emissivity of less than 0.5. Here, “emissivity” is defined as the ratio of the energy radiated from a material's surface to that radiated from a blackbody (a perfect emitter) at the same temperature and wavelength and under the same viewing conditions. Reducing emissivity helps lower the extent to which a material loses heat from thermal radiation. The fluoropolymer binder can be used in the current application can include, but not limited to, THV (a polymer of tetrafluoroethylene, hexafluoropropylene and vinylidene fluoride) or Tetrafluoroethylene (TFE Teflon), Hexafluoropropylene (HFP), and Vinylidene fluoride (VDF). Fluoropolymer binder can include fluorinated binders, such as fluorinated acrylate.

The fluoropolymer binder can be applied to the plurality of randomly-oriented fibers by any suitable means, for example, coating. Fluoropolymers of the nonwoven fabric 100 can impart various functional and/or aesthetic benefits. For example, fluoropolymers on the fibers have the effect of reinforcing the fibers, thus increasing the overall strength of the web. Fluoropolymers may also enhance resistance to staining or fouling caused by airborne substances becoming adhered to fiber surfaces.

In some embodiments, the nonwoven fabric of the current application has a low flow resistance, for example less than 1000 Ray, 100 Rayl, 50 Rayl, 30 Rayl, 25 Rayl, 20 Rayl, 15 Rayl, 10 Rayl. Low flow resistance can render the nonwoven fabric-core assembly better acoustic insulators. Flow resistance may be changed by the amount of the fluoropolymer binder. Increasing the amount of the fluoropolymer binder can provide higher flow resistance and decreasing the amount of the fluoropolymer binder can provide lower flow resistance.

In some embodiments, the nonwoven fabric of the current application has a high flow resistance, for examples higher than 1000 Rayls, or 10,000 Rayls. High flow resistance can render the nonwoven fabric better for thermal insulation, since such high flow resistance help to block the air flow conduction.

In some embodiments, the nonwoven fabric 100 can includes entangled regions 110. The entangled regions 110 represent places where two or more discrete fibers 108 have become twisted together. The fibers within these entangled regions 110, although not physically attached, are so intertwined that they resist separation when pulled in opposing directions.

In some embodiments, the entanglements are induced by a needle tacking process or hydroentangling process. Each of these processes are described in more detail below.

The nonwoven fabric can be needle tacked using a conventional needle tacking apparatus (e.g., a needle tacker commercially available under the trade designation DILO from Dilo of Germany, with barbed needles (commercially available, for example, from Foster Needle Company, Inc., of Manitowoc, Wis.) whereby the substantially entangled fibers described above are needle tacked fibers. Needle tacking, also referred to as needle punching, entangles the fibers perpendicular to the major surface of the nonwoven fabric by repeatedly passing an array of barbed needles through the web and retracting them while pulling along fibers of the web.

The needle tacking process parameters, which include the type(s) of needles used, penetration depth, and stroke speed, are not particularly restricted. Further, the optimum number of needle tacks per area of mat will vary depending on the application. Typically, the nonwoven fabric is needle tacked to provide an average of at least 5 needle tacks/cm². Preferably, the mat is needle tacked to provide an average of about 5 to 60 needle tacks/cm², more preferably, an average of about 10 to about 20 needle tacks/cm².

Further options and advantages associated with needle tacking are described elsewhere, for example in U.S. Patent Publication Nos. 2006/0141918 (Rienke) and 2011/0111163 (Bozouklian et al.).

The nonwoven fabric can be hydroentangled using a conventional water entangling unit (commercially available from Honeycomb Systems Inc. of Bidderford, Me.; also see U.S. Pat. No. 4,880,168 (Randall, Jr.), the disclosure of which is incorporated herein by reference for its teaching of fiber entanglement). Although the preferred liquid to use with the hydroentangler is water, other suitable liquids may be used with or in place of the water.

In a water entanglement process, a pressurized liquid such as water is delivered in a curtain-like array onto a nonwoven fabric, which passes beneath the liquid streams. The mat or web is supported by a wire screen, which acts as a conveyor belt. The mat feeds into the entangling unit on the wire screen conveyor beneath the jet orifices. The wire screen is selected depending upon the final desired appearance of the entangled mat. A coarse screen can produce a mat having perforations corresponding to the holes in the screen, while a very fine screen (e.g., 100 mesh) can produce a mat without the noticeable perforations.

FIG. 2 shows a nonwoven fabric 200 which, like nonwoven fabric 100, has opposed first and second major surfaces 204, 206. The nonwoven fabric 200 differs from that of the prior example in that it includes both a plurality of oxidized polyacrylonitrile fibers 208 and a plurality of reinforcing fibers 216. As indicated by the color contrast in FIG. 2, the nonwoven fabric includes a fluoropolymer binder on the plurality of randomly-oriented fibers, for example, on the oxidized polyacrylonitrile fibers 208 and reinforcing fibers 216.

The reinforcing fibers 216 may include binder fibers, which have a sufficiently low melting temperature to allow subsequent melt processing of the nonwoven fabric 200. Binder fibers are generally polymeric, and may have uniform composition or contain two or more components. In some embodiments, the binder fibers are bi-component fibers comprised of a core polymer that extends along the axis of the fibers and is surrounded by a cylindrical shell polymer. The shell polymer can have a melting temperature less than that of the core polymer. The reinforcing fibers can include at least one of monocomponent or multi-component fibers. In some embodiments, the reinforcing fiber can include polyethylene terephthalate, polyphenylene sulfide, poly-aramide, polylactic acid. In some embodiments, the reinforcing fibers can be multicomponent fibers having an outer shealth comprising polyolefin. In some embodiments, the polyolefin can be selected from the group consisting of polyethylene, polypropylene, polybutylene, polyisobutylene, polyethylene naphthalate, and combinations thereof.

As used herein, however, “melting” refers to a gradual transformation of the fibers or, in the case of a bi-component shell/core fiber, an outer surface of the fiber, at elevated temperatures at which the polyester becomes sufficiently soft and tacky to bond to other fibers with which it comes into contact, including oxidized polyacrylonitrile fibers and any other binder fibers having its same characteristics and, as described above, which may have a higher or lower melting temperature.

Useful binder fibers have outer surfaces comprised of a polymer having a melting temperature of from 100° C. to 450° C., or in some embodiments, less than, equal to, or greater than, 100° C., 105, 110, 115, 120, 125, 130, 135, 140, 145, 150, 160, 170, 180, 190, 200, 210, 220, 230, 240, 250, 260, 270, 280, 290, 300, 325, 350, 375, 400, 425° C.

Exemplary binder fibers include, for example, a bi-component fiber with a polyethylene terephthalate core and a copolyester sheath. The sheath component melting temperature is approximately 230° F. (110° C.). The binder fibers can also be a polyethylene terephthalate homopolymer or copolymer rather than a bi-component fiber.

The binder fibers increase structural integrity in the insulator 200 by creating a three-dimensional array of nodes where constituent fibers are physically attached to each other. These nodes provide a macroscopic fiber network, which increases tear strength, tensile modulus, preserves dimensional stability of the end product, and minimizes fiber shedding. Advantageously, incorporation of binder fibers can allow bulk density to be reduced while preserving structural integrity of the nonwoven fabric, which in turn decreases both weight and thermal conductivity.

It was found that thermal conductivity coefficient □ for the nonwoven fabric 100, 200 can be strongly dependent on its average bulk density. When the average bulk density of the nonwoven fabric is significantly higher than 50 kg/m³, for example, a significant amount of heat can be transmitted through the insulator by thermal conduction through the fibers themselves. When the average bulk density is significantly below 15 kg/m³, heat conduction through the fibers is small but convective heat transfer can become significant. Further reduction of average bulk density can also significantly degrade strength of the nonwoven fabric, which is not desirable.

In exemplary embodiments, the nonwoven fabric 100, 200 has a basis weight of from 10 gsm to 100 gsm, 15 gsm to 50 gsm, 20 gsm to 30 gsm, or in some embodiments less than, equal to, or greater than 10 gsm, 16, 17, 18, 19, 20, 22, 24, 25, 26, 28, 30, 32, 35, 37, 40, 42, 45, 47, 50, 60, 70, 80, 90, 100 gsm.

In exemplary embodiments, the nonwoven fabric 100, 200 has an average bulk density of from 100 kg/m³ to 1500 kg/m³, 150 kg/m³ to 1000 kg/m³, 200 kg/m³ to 500 kg/m³, or in some embodiments less than, equal to, or greater than 100 kg/m³, 150, 200, 250, 300, 350, 400, 450, 500, 550, 600, 650, 700, 750, 800, 850, 900, 950, 1000, 1100, 1200, 1300, 1400, or 1500 kg/m³.

The oxidized polyacrylonitrile fibers 208 in the nonwoven fabric 200 are not combustible. Surprisingly, it was found that combustion of the reinforcing fibers in the FAR 25-856a flame test did not result in significant dimensional changes (no shrinkage and no expansion) in the nonwoven fabric. The nonwoven fabric can pass the UL-94V0 flame test. This benefit appears to have been the effect of the fiber entanglements perpendicular to the major surface of the nonwoven fabric.

The oxidized polyacrylonitrile fibers 208 can be present in any amount sufficient to provide adequate flame retardancy and insulating properties to the nonwoven fabric 200. The oxidized polyacrylonitrile fibers 208 can be present in an amount of from 60 wt % to 100 wt %, 70 wt % to 100 wt %, 81 wt % to 100 wt %, or in some embodiments, less than, equal to, or greater than 50 wt %, 55, 60, 65, 70, 75, 80, 85, 90, or 95 wt %, or less than or equal to 100 wt %. The reinforcing fibers 216 can be present in an amount of from 0 wt % to less than 40 wt %, 3 wt % to 30 wt %, 0 wt % to 19 wt %, 3 wt % to 19 wt %, or in some embodiments, equal to or greater than 0 wt %, or less than, equal to, or greater than 1 wt %, 2, 3, 4, 5, 7, 10, 15, 20, 25, 30, 35, or 40 wt %.

Preferred weight ratios of the oxidized polyacrylonitrile fibers 208 to reinforcing fibers 216 bestow both high tensile strength to tear resistance to the nonwoven fabric 200 as well as acceptable flame retardancy—for instance, the ability to pass the UL-94V0 flame test. The weight ratio of oxidized polyacrylonitrile fibers to reinforcing fibers can be at least 4:1, at least 5:1, at least 10:1, or in some embodiments, less than, equal to, or greater than 4:1, 5:1, 6:1, 7:1, 8:1, 9:1, or 10:1.

Optionally and as shown in the figures, the oxidized polyacrylonitrile fibers 108, 208 and reinforcing fibers 116, 216 are each crimped to provide a crimped configuration (e.g., a zigzag, sinusoidal, or helical shape). Alternatively, some or all of the oxidized polyacrylonitrile fibers 108, 208 and reinforcing fibers 116, 216 have a linear configuration. The fraction of oxidized polyacrylonitrile fibers 108, 208 and/or reinforcing fibers 116, 216 that are crimped can be less than, equal to, or greater than 5%, 10, 15, 20, 25, 30, 40, 50, 60, 70, 80, 90, or 100%. Crimping, which is described in more detail in European Patent No. 0 714 248, can significantly increase the bulk, or volume per unit weight, of the non-woven fibrous web.

Other aspects of the nonwoven fabric 200 are analogous to those described already with respect to nonwoven fabric 100 and shall not be repeated here.

The nonwoven fabrics of the thermal insulators described with respect to FIGS. 1-2 can have any suitable thickness based on the space allocated for the application at hand. For common applications, the nonwoven fabrics can have a thickness of less than 1 millimeter or 0.5 millimeters.

As described previously, many factors influence the mechanical properties displayed by the nonwoven fabric, including fiber dimensions, the presence of binding sites on the reinforcing fibers, fiber entanglements, and overall bulk density. Tensile strength and tensile modulus are metrics by which the properties of the nonwoven fabric may be characterized.

Tensile strength represents the resistance of the nonwoven fabric to tearing or permanently distorting and can be at least 28 kPa, at least 32 kPa, at least 35 kPa, or in some embodiments, less than, equal to, or greater than 28 kPa, 29, 30, 31, 32, 33, 34, 35, 36, 37, 38, 39, 40, 42, 44, 45, 47, or 50 kPa.

Surprisingly, it was found that entangling the fibers of the nonwoven fabric perpendicular to the major surfaces of the web to produce a material having a bulk density in the range of from 15 kg/m³ to 500 kg/m³ solved a technical problem associated with volumetric expansion in the UL-94V0 or FAR 25-856a flame test. Specifically, it was discovered that while conventional oxidized polyacrylonitrile materials were observed to swell substantially after flame testing, the provided thermal insulators do not. In some embodiments, the provided nonwoven fabrics deviate less than 10%, less than 7%, less than 5%, less than 4%, or less than 3%, or in some embodiments, less than, equal to, or greater than 10%, 9, 8, 7, 6, 5, 4, or 3% in thickness after flame testing, relative to its original dimensions.

The nonwoven fabric 100, 200 may optionally include additional layers not explicitly shown in FIGS. 1-2. To assist in installation, for example, any of these exemplary thermal insulators may further include an adhesive layer, such as a pressure-sensitive adhesive layer or other attachment layer extending across and contacting the nonwoven fabric. As another possibility, any of these insulators may include a solid thermal barrier such as an aluminum sheet or foil layer adjacent to the nonwoven fabric. For some applications, one or more acoustically insulating layers may also be coupled to the nonwoven fabric.

The nonwoven fabric can be made by mixing a plurality of oxidized polyacrylonitrile fibers with a plurality of reinforcing fibers to form a mixture of randomly-oriented fibers as described in the commonly owned PCT Patent Publication No. WO 2015/080913 (Zillig et al). The mixture of randomly-oriented fibers is then heated to a temperature sufficient to melt the outer surfaces of the plurality of reinforcing fibers. The fluoropolymer binder can be applied to the mixture of randomly-oriented fibers. As a result, the mixture of randomly-oriented fibers can be bonded together to form the nonwoven fabric.

In some embodiments, the major surface of the non-woven fabric can be smoothed. The smoothed surfaces may be obtained by any known method. For example, smoothing could be achieved by calendaring the non-woven fibrous web, heating the non-woven fibrous web, and/or applying tension to the non-woven fibrous web. In some embodiments, the smoothed surfaces are skin layers produced by partial melting of the fibers at the exposed surfaces of the non-woven fibrous web.

In some embodiments, there may be a density gradient at the smoothed surface. For example, portions of the smoothed surface proximate to the exposed major surface may have a density greater than portions remote from the exposed major surface. Increasing bulk density at one or both of the smoothed surfaces can further enhance tensile strength and tear resistance of the non-woven fibrous web. The smoothing of the surface can also reduce the extent of fiber shedding which would otherwise occur in handling or transporting the non-woven fabric. Still another benefit is the reduction in thermal convection by impeding the passage of air through the non-woven fibrous web. The one or both smoothed surfaces may, in some embodiments, be non-porous such that air is prevented from flowing through the non-woven fabric.

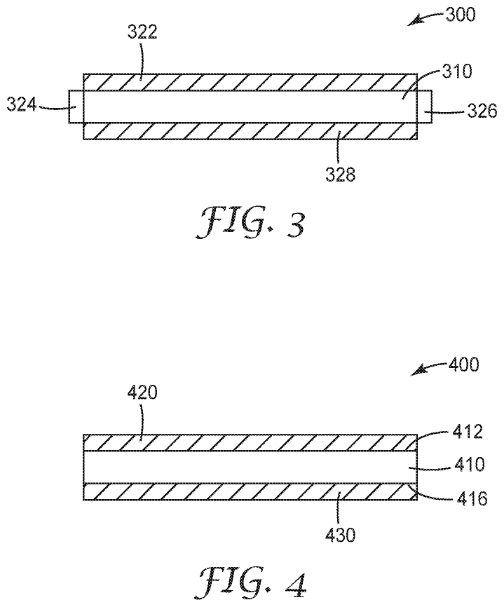

FIG. 3 is a schematic of nonwoven fiber assembly 300 according to one exemplary embodiment. The nonwoven fiber assembly 300 includes a nonwoven fibrous web 310. The nonwoven fibrous web 310 includes a plurality of discontinuous fibers. The plurality of discontinuous fibers can be selected from oxidized polyacrylonitrile fibers, polyolefin fibers, polyester fibers, polyamide fibers, block copolymer fibers, or a combination thereof. The nonwoven fibrous web is at least partially surrounded by the nonwoven fabric of the current application. As shown in FIG. 5, nonwoven fabric 322, 324, 326, 328 are disposed around the nonwoven fibrous web 310, partially surrounding it to provide insulation from the external environment.

FIG. 4 is a schematic of nonwoven fiber assembly 400 according to one exemplary embodiment. The nonwoven fiber assembly 400 includes a nonwoven fibrous web 410 web having a first major surface 412 and an opposed second major surface 416. The nonwoven fibrous web 410 includes a plurality of discontinuous fibers. The plurality of discontinuous fibers can be selected from oxidized polyacrylonitrile fibers, polyolefin fibers, polyester fibers, polyamide fibers, block copolymer fibers, or a combination thereof. Fiber assembly 400 includes a first nonwoven fabric 420 covering at least a portion of the first major surface 412 and a second nonwoven fabric 430 covering at least a portion of the second major surface 416.

While not intended to be exhaustive, a list of exemplary embodiments is provided as follows:
1. A nonwoven fiber assembly comprising: a nonwoven fibrous web comprising a plurality of discontinuous fibers; and a nonwoven fabric at least partially surrounding the nonwoven fibrous web; the nonwoven fabric comprising a plurality of randomly-oriented fibers, the plurality of randomly-oriented fibers comprising: at least 60 wt % of oxidized polyacrylonitrile fibers; and from 0 to less than 40 wt % of reinforcing fibers having an outer surface comprised of a (co)polymer with a melting temperature of from 100° C. to 450° C.; and a fluoropolymer binder on the plurality of randomly-oriented fibers; wherein the plurality of randomly-oriented fibers is bonded together to form the nonwoven fabric, optionally wherein the non-woven fabric has a thickness less than one millimeter.
2. The nonwoven fiber assembly of embodiment 1, wherein the reinforcing fibers comprise at least one of monocomponent or multi-component fibers.
3. The nonwoven fiber assembly of embodiment 2, wherein the reinforcing fiber comprising polyethylene terephthalate, polyphenylene sulfide, poly-aramide, polylactic acid.
4. The nonwoven fiber assembly of embodiment 2, wherein the reinforcing fibers are multicomponent fibers having an outer shealth comprising polyolefin.
5. The nonwoven fiber assembly of embodiment 2, wherein the polyolefin is selected from the group consisting of polyethylene, polypropylene, polybutylene, polyisobutylene, polyethylene naphthalate, and combinations thereof.
6. The nonwoven fiber assembly of any one of embodiments 1-5, wherein the nonwoven fabric has a thickness of less than 0.5 millimeter.
7. The nonwoven fiber assembly of any one of embodiments 1-6, wherein the nonwoven fabric has a basis weight of from 10 gsm to 100 gsm.
8. The nonwoven fiber assembly of any one of embodiments 1-7, wherein the nonwoven fabric has a tensile strength of more than 28 kPa.
9. The nonwoven fiber assembly of any one of embodiments 1-8, wherein the nonwoven fiber assembly passes the UL-94V0 flame test.
10. The nonwoven fiber assembly of any one of embodiments 1-9, wherein the plurality of randomly-oriented fibers has an average bulk density of from 100 kg/m³ to 1500 kg/m³.
11. The nonwoven fiber assembly of any one of embodiments 1-10, wherein the plurality of randomly-oriented fibers contains from 0 to 19 wt % of reinforcing fibers having an outer surface comprised of a (co)polymer with a melting temperature of from 100° C. to 450° C.
12. The nonwoven fiber assembly of any one of embodiments 1-11, wherein the oxidized polyacrylonitrile fibers have a median Effective Fiber Diameter of from 5 micrometers to 50 micrometers.
13. The nonwoven fiber assembly of any one of embodiments 1-12, wherein the fluoropolymer binder comprises THV or Tetrafluoroethylene (TFE Teflon), Hexafluoropropylene (HFP), and Vinylidene fluoride (VDF).
14. The nonwoven fiber assembly of any one of embodiments 1-11, wherein the plurality of discontinuous fibers is selected from oxidized polyacrylonitrile fibers, polyolefin fibers, polyester fibers, polyamide fibers, block copolymer fibers, or a combination thereof.
15. The nonwoven fiber assembly of any one of embodiments 1-11, wherein the flow resistance of the nonwoven fiber assembly is less than 50 Rayls.
16. A nonwoven fabric assembly comprising: a non-woven fibrous web comprising a plurality of discontinuous fibers, the nonwoven fibrous web having a first major surface and an opposed second major surface; a first nonwoven fabric covering at least a portion of the first major surface; and a second nonwoven fabric covering at least a portion of the second major surface; wherein the first and second non-woven fabrics each comprises a plurality of randomly-oriented fibers, the plurality of randomly-oriented fibers comprising:
at least 60 wt % of oxidized polyacrylonitrile fibers; and less than 40 wt % of reinforcing fibers having an outer surface comprised of a (co)polymer with a melting temperature of from 100° C. to 450° C.; and a fluoropolymer binder on the plurality of randomly-oriented fibers; wherein the plurality of randomly-oriented fibers is bonded together to form the first or second nonwoven fabrics, optionally wherein the first and second nonwoven fabrics each has a thickness of one millimeter or less.
17. The nonwoven fabric assembly of embodiment 16, wherein the non-woven fibrous web comprises polyethylene terephthalate/polyphenylene combo web, polyethylene terephthalate web or polyurethane web.
18. The nonwoven fabric assembly of any one of embodiments 16-17, wherein the plurality of discontinuous fibers is selected from oxidized polyacrylonitrile fibers, polyolefin fibers, polyester fibers, polyamide fibers, block copolymer fibers, or a combination thereof.
19. The nonwoven fabric assembly of any one of embodiments 16-18, wherein the reinforcing fibers comprise at least one of monocomponent or multi-component fibers.
20. The nonwoven fabric assembly of embodiment 19, wherein the reinforcing fiber comprising polyethylene terephthalate, polyphenylene sulfide, poly-aramide, polylactic acid.
21. The nonwoven fabric of any one of embodiments 1-14, wherein the flow resistance of the nonwoven fabric is more than 1000 Rayls.

### EXAMPLES

Objects and advantages of this disclosure are further illustrated by the following non-limiting examples, but the materials and amounts thereof recited in these examples, as well as other conditions and details, should not be construed to unduly limit this disclosure.

TABLE 1
Materials

| Designation | Description | Source |
|---|---|---|
| OPAN | Oxidized polyacrylonitrile staple fibers, | Zoltek ™ Corporation |
| | 1.7 dTex available under the trade | (wholly owned subsidiary of |
| | designation “OX” | Toray Group), Bridgeton, |
| | | MO. United States |
| THV340Z | Dispersion (50 wt. %) of a polymer of | 3M Company, Saint Paul, |
| | tetrafluoroethylene, | MN. United States |
| | hexafluoropropylene, and vinylidene | |
| | fluoride available under the trade | |
| | designation “3M DYNEON | |
| | Fluoroplastic THV 340Z) | |
| T270 | A flame retardant polyethylene | Trevira GmbH, Hattersheim, |
| | terephthalate staple fiber, 6.5 dTex, | Germany. |
| | available under the trade designation | |
| | “TREVIRA 270” | |
| PET Liner | One side silicone treated polyethylene | Mitsubishi Polyester Film, |
| | terephthalate available under the | Greer, SC, United States. |
| | designation “215KN” | |
| OPTIVEIL | Fiberglass with a polyimide binder, 10 | Technical Fibre Products, |
| | gsm available under the trade | Kendal, Cumbria, United |
| | designation “OPTIVEIL” | Kingdom |
| TC1503 | Acoustic insulation web composed of | 3M Company, Saint Paul, |
| | 50% polyester staple fibers and 50% | MN. United States |
| | polypropylene fibers encapsulated | |
| | between 100% polypropylene nonwoven | |
| | fabrics, 155 gsm and nominal thickness | |
| | 16 mm available under the trade | |
| | designation “3M THINSULATE | |
| | TC1503” | |
| HT400P | High temperature acoustic absorber | 3M Company, Saint Paul, |
| | featuring a web of polyester fibers with | MN. United States |
| | encapsulating protective scrim removed, | |
| | 300 gsm available under the trade | |
| | designation “3M THINSULATE | |
| | HT400P” | |
| FR PET Scrim | A flame retardant polyethylene | Precision Fabrics Group, |
| | terephthalate scrim material, 50 gsm | Inc., Greensboro, NC. |
| | | United States |

### Test Methods

Nonwoven Web Thickness Measurement: The method of ASTM D5736-95 was followed, according to test method for thickness of high loft nonwoven fabrics. The plate pressure was calibrated at 0.002 psi (13.790 Pascal).

UL94-V0 Flame Test: Reference to UL94-V0 standard with flame height 20-mm, bottom edge of the sample 10-mm into the flame and burn twice at 10 seconds each. A flame propagation height under 125-mm (5 inches) was considered a pass.

Nonwoven webs or fabrics produced in the following examples and comparative examples were produced by processes and techniques described in the commonly owned PCT Patent Publication No. WO 2015/080913 (Zillig et al) unless otherwise stated. Fabrics (i.e., samples) were produced by processing the nonwoven webs with binder solutions.

### Example 1 (EX1)

A web was produced with 100 wt. % OPAN. The basis weight was 15 gsm±10%. The web was placed on a first PET liner with the silicone release side directed toward the OPAN web. A 90 gsm THV340Z binder solution (diluted from 50 wt. % to 16 wt. % solid content by adding two parts of water to the one part of the solution) was spray coated onto the web. The OPAN web with binder at 3 mm thickness was uniformly compressed by a hand roller to a 0.5 mm thickness. The OPAN web with binder, supported by the PET liner, was then placed into an ISOTEMP Oven from Fisher Scientific of Waltham, Mass. United States at 160° C. (320° F.) oven for 2-4 minutes to dry producing a 15 gsm±10% dry coating of the THV340Z binder. A second PET liner was placed on top of the OPAN web supported by the first PET liner. The sample was then calendared at a gap of 1.5 mil and speed of 0.305 m/min (1 ft./min) in the oven with an upper temperature setting of 152° C. (305° F.) and lower temperature of 154° C. (310° F.). The basis weight of the sample was 30 gsm±10%. The sample underwent UL94-V0 Flame testing. Results are represented in Table 1.

### Example 2 (EX2)

A 80 wt. % OPAN and 20 wt. % T270 blended web was produced. The blended web was heated in the oven at 249° C. (480° F.) enhancing entanglement and strength. The web was placed on a PET liner with the silicone release side directed toward the OPAN web. The basis weight was 20 gsm±10%. A 140 gsm THV340Z binder solution (diluted from 50 wt. % to 10 wt. % solid content by adding two parts of water to the one part of the solution) was spray coated onto the web. The OPAN web with binder at 3 mm thickness was uniformly compressed by a hand roller to a 0.5 mm thickness. The OPAN web with binder, supported by the PET liner, was then placed into an ISOTEMP Oven from Fisher Scientific of Waltham, Mass. United States at 160° C. (320° F.) oven for 2-4 minutes to dry producing a 14 gsm±10% dry coating of the THV340Z binder. The basis weight of the sample was 34 gsm±10%. The sample underwent UL94-V0 Flame testing. Results are represented in Table 1.

### Comparative Example 1 (CE1)

A 20-mm thick sample of OPTIVEIL underwent UL94-V0 Flame testing. Results are represented in Table 1.

### Comparative Example 2 (CE2)

A 20-mm thick sample of HT400P underwent UL94-V0 Flame. Results are represented in Table 1.

### Example 3 (EX3)

A sample was prepared as described in Example 1. The sample was wrapped around a 20-mm thick HT400P sample. The combined basis weight was 360 gsm±10%. The sample underwent UL94-V0 Flame testing. Results are represented in Table 1.

### Example 4 (EX4)

A sample was prepared as described in Example 2. The sample was wrapped around a 20-mm thick HT400P. The combined basis weight was 368 gsm±10%. The sample underwent UL94-V0 Flame testing. Results are represented in Table 1.

### Comparative Example 3 (CE3)

A 15-mm thick sample of TC1503 underwent UL94-V0 Flame testing. Results are represented in Table 1.

### Comparative Example 4 (CE4)

A FR PET scrim was wrapped around a 15-mm thick TC1503 sample. The combined basis weight was 255 gsm±10%. The sample underwent UL94-V0 Flame testing. Results are represented in Table 1.

### Example 5 (EX5)

A sample was prepared as described in Example 1. The sample was wrapped around a 15-mm thick TC1503 sample. The combined basis weight was 215 gsm±10%. The sample underwent UL94-V0 Flame testing. Results are represented in Table 1.

### Example 6 (EX6)

A sample was prepared as described in Example 2. The sample was wrapped around a 15-mm thick TC1503 sample. The combined basis weight was 223 gsm±10%. The sample underwent UL94-V0 Flame testing. Results are represented in Table 1.

TABLE 1
UL94-V0 Flame and Airflow Resistance Test Results

| | UL94-V0 Flame Test |
|---|---|
| EX1 | Pass |
| EX2 | Fail |
| CE1 | Fail |
| CE2 | Fail |
| EX3 | Pass |
| EX4 | Pass |
| CE3 | Fail |
| CE4 | Fail |
| EX5 | Pass |
| EX6 | Pass |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given to enable one of ordinary skill in the art to practice the claimed disclosure, is not to be construed as limiting the scope of the disclosure, which is defined by the claims and all equivalents thereto.

1. A nonwoven fiber assembly comprising:
a nonwoven fibrous web comprising a plurality of discontinuous fibers; and
a nonwoven fabric at least partially surrounding the nonwoven fibrous web;
the nonwoven fabric comprising
a plurality of randomly-oriented fibers, the plurality of randomly-oriented fibers comprising:
at least 60 wt % of oxidized polyacrylonitrile fibers; and
from 0 to less than 40 wt % of reinforcing fibers having an outer surface comprised of a (co)polymer with a melting temperature of from 100° C. to 450° C.; and
a fluoropolymer binder on the plurality of randomly-oriented fibers;
wherein the plurality of randomly-oriented fibers is bonded together to form the nonwoven fabric, optionally wherein the non-woven fabric has a thickness less than one millimeter.

2. The nonwoven fiber assembly of claim 1, wherein the reinforcing fibers comprise at least one of monocomponent or multi-component fibers.

3. The nonwoven fiber assembly of claim 2, wherein the reinforcing fibers comprise polyethylene terephthalate, polyphenylene sulfide, poly-aramide, or polylactic acid.

4. The nonwoven fiber assembly of claim 2, wherein the reinforcing fibers are multicomponent fibers having an outer sheath comprising polyolefin.

5. The nonwoven fiber assembly of claim 4, wherein the polyolefin is selected from the group consisting of polyethylene, polypropylene, polybutylene, polyisobutylene, polyethylene naphthalate, and combinations thereof.

6. The nonwoven fiber assembly of claim 1, wherein the nonwoven fabric has a thickness of less than 0.5 millimeter.

7. The nonwoven fiber assembly of claim 1, wherein the nonwoven fabric has a basis weight of from 10 gsm to 100 gsm.

8. The nonwoven fiber assembly of claim 1, wherein the nonwoven fabric has a tensile strength of more than 28 kPa.

9. The nonwoven fiber assembly of claim 1, wherein the nonwoven fiber assembly passes the UL-94V0 flame test.

10. The nonwoven fiber assembly of claim 1, wherein the plurality of randomly-oriented fibers has an average bulk density of from 100 kg/m³ to 1500 kg/m³.

11. The nonwoven fiber assembly of claim 1, wherein the plurality of randomly-oriented fibers contains from 0 to 19 wt % of reinforcing fibers having an outer surface comprised of a (co)polymer with a melting temperature of from 100° C. to 450° C.

12. The nonwoven fiber assembly of claim 1, wherein the oxidized polyacrylonitrile fibers have a median Effective Fiber Diameter of from 5 micrometers to 50 micrometers.

13. The nonwoven fiber assembly of claim 1, wherein the fluoropolymer binder comprises THV or Tetrafluoroethylene (TFE Teflon), Hexafluoropropylene (HFP), and Vinylidene fluoride (VDF).

14. The nonwoven fiber assembly of any one of claims 1-11, wherein the plurality of discontinuous fibers is selected from oxidized polyacrylonitrile fibers, polyolefin fibers, polyester fibers, polyamide fibers, block copolymer fibers, or a combination thereof.

15. The nonwoven fiber assembly of claim 1, wherein the flow resistance of the nonwoven fiber assembly is less than 50 Rayls.

16. A nonwoven fabric assembly comprising:
a non-woven fibrous web comprising a plurality of discontinuous fibers, the nonwoven fibrous web having a first major surface and an opposed second major surface;
a first nonwoven fabric covering at least a portion of the first major surface; and
a second nonwoven fabric covering at least a portion of the second major surface;
wherein the first and second non-woven fabrics each comprises
a plurality of randomly-oriented fibers, the plurality of randomly-oriented fibers comprising:
at least 60 wt % of oxidized polyacrylonitrile fibers; and
less than 40 wt % of reinforcing fibers having an outer surface comprised of a (co)polymer with a melting temperature of from 100° C. to 450° C.; and
a fluoropolymer binder on the plurality of randomly-oriented fibers;
wherein the plurality of randomly-oriented fibers is bonded together to form the first or second nonwoven fabrics, optionally wherein the first and second nonwoven fabrics each has a thickness of one millimeter or less.

17. The nonwoven fabric assembly of claim 16, wherein the non-woven fibrous web comprises a polyethylene terephthalate/polyphenylene combo web, a polyethylene terephthalate web or a polyurethane web.

18. The nonwoven fabric assembly of claim 16, wherein the plurality of discontinuous fibers is selected from oxidized polyacrylonitrile fibers, polyolefin fibers, polyester fibers, polyamide fibers, block copolymer fibers, or a combination thereof.

19. The nonwoven fabric assembly of claim 16, wherein the reinforcing fibers comprise at least one of monocomponent or multi-component fibers.

20. The nonwoven fabric assembly of claim 19, wherein the reinforcing fibers comprise polyethylene terephthalate, polyphenylene sulfide, poly-aramide, or polylactic acid.
